(19) United States
(12) Patent Application Publication
(10) Pub. No.: US 2012/0070673 A1
(43) Pub. Date: Mar. 22, 2012

(54) COATING COMPOSITION

(76) Inventors: Mattias Kuntz, Seeheim-Jugenheim (DE); Ulrich Schoenefeld, Bickenbach (DE); Anna Lange, Griesheim (DE); Frank Jochen Maile, Seeheim-Jugenheim (DE); Johanna Schuetz-Widoniak, Seeheim-Jugenheim (DE)

(21) Appl. No.: 13/257,445

(22) PCT Filed: Feb. 25, 2010
(86) PCT No.: PCT/EP10/01171

§ 371 Date: Dec. 5, 2011

(30) Foreign Application Priority Data
Mar. 20, 2009 (DE) 10 2009 016 089 2

(51) Int. Cl. B05D 3/02; C09D 133/08; C01B 35/10; C01F 7/02; C09D 1/00; B32B 9/00; C09D 7/12; B82Y 30/00

(52) U.S. Cl. 428/446; 427/372.2; 524/560; 423/277; 423/625; 106/482; 106/401; 106/436; 106/450; 106/456; 106/453; 106/287.1; 106/287.17; 977/773

(57) ABSTRACT

The present invention relates to a pigmented coating composition for an automobile clear coat, to the use of a coating composition of this type, to an automobile clear coat, and to a process for the coating of an automobile with a clear coat.

The present invention relates to a coating composition for an automobile clear coat, to the use of a coating composition of this type, to a clear coat produced by means of this coating composition, and to a process for the coating of an automobile with a clear coat.

Automotive paints have to fulfil many functions. They provide the vehicle with colour and gloss, but are also intended to provide durable protection against external influences, such as UV rays, road salt, acid rain and other environmental influences, bird excrement, stone impact, mechanical stress and chemical attack by car washes, and many others, while maintaining their visual impression unimpaired over the longest possible time. In the best case, an attractive automotive paint promotes and supports value and exclusivity of the vehicle.

It is therefore not surprising that high demands are made both of the procedure of application of vehicle finishes and also of the chemical composition and optical and functional interplay of the individual coats of a vehicle finish.

For high-value vehicle models, two different types of coating have generally become established, namely the two-coat finish and the three-coat finish, where the former is used preferentially.

In the case of the two-coat finish, a base coat, which, besides binders and additives and assistants for improving the flow behaviour and adhesion properties, comprises, in particular, coloured pigments, which provide the vehicle with the visible colour, is firstly applied to the prepared (e-coat, filler, etc.) body parts. A base coat must be applied to provide opacity, so that it completely covers the surface of the primed body parts. If it is intended to provide the vehicle with particular coloured effects, such as metal lustre, pearl lustre, glitter effects or colour flops, mixtures of organic and/or inorganic absorption pigments and/or pigment-grade carbon black and the so-called effect pigments, which include metal pigments and pearlescent pigments, in the base coat have now become standard state of the art. However, the pigments in the base coat influence one another in a disadvantageous manner here, since effect pigments are frequently not opaque and the entire pigment content of the base coat cannot exceed certain proportions by weight without the flow properties of the paint or its durability being reduced. The additional gloss, glitter and colour-flop effects in the base coat which can be achieved by means of, in particular, transparent effect pigments are therefore only relatively weakly pronounced, since a combination of these non-hiding pigments with absorption pigments is vital for an opaque base coat.

In order to protect the base coat against the external influences already mentioned above, an unpigmented clear coat is finally applied. This comprises additives which are employed, inter alia, for the light fastness, weather resistance, chemical and heat resistance, scratch resistance and solvent resistance of the finish. In particular, the light fastness of the base coat must be established if the latter comprises effect pigments, such as pearlescent pigments or interference pigments based on mica which are coated with metal oxides, in particular with titanium dioxide. Although these pigments are generally already provided with additional post-coatings which are intended to reduce the known photoactivity of titanium dioxide, a further protective layer which comprises UV-stabilising assistants on the base coat is highly desirable.

Since, as described above, the demands on the base coat and clear coat are very different, their chemical composition is generally also very different and customised specifically to the desired application.

The clear coat can be applied to the base coat with or without interim drying and interim curing. In general, the clear coat is applied after brief drying of the base coat. The entire coating system is subsequently dried jointly and subjected to a curing process.

In contrast to the two-coat finish, a base coat is applied in two layers lying one above the other in the case of the three-coat finish. Besides the conventional additives and assistants, the lower base coat here comprises, in particular, absorption pigments, while the upper base coat comprises merely effect pigments and generally no absorption pigments. In this way, an opaque absorption colour layer, which shows the specific optical effects of the effect pigments located in the upper layer to their best advantage, can be introduced below the layer comprising the effect pigments. In addition, the concentration of effect pigments in the second base coat can be increased compared with the base coat in the case of the two-coat finish, which can in turn result in better gloss, glitter or colour-flop effects. Apart from the type of pigmentation, the chemical composition of the two base coats in this type of finish is essentially the same or similar, since both must meet the same requirements.

Precisely as in the case of the two-coat finish, the coating process here is again completed with the application of a clear coat which has the structure as described above. Although the three-coat finish may under certain circumstances result in better optical special effects which are attributable to the influence of the effect pigments in the second base coat, the economic disadvantages of a process of this type are obvious. With the application of a third coat, three coating steps are necessary, including the respective preparatory and finishing work, as well as extensive equipment. The optical effects which can be achieved here often bear no economic relation to the requisite effort.

There have also already been attempts to “colour” the final clear coat to a certain extent in order to enhance the hiding power and brightness of the colour effect which can be achieved by the base coat(s). For this purpose, organic or inorganic colorants, often of a soluble nature, are employed in low concentrations. Inorganic transparent effect pigments, in particular pearlescent or interference pigments coated with metal oxides, such as titanium dioxide, have hitherto not been described in automobile clear coats, which is highly probably attributable to the known problems explained above with the light stability thereof or the yellowing tendency of paints pigmented therewith, as well as further processing difficulties (settling tendency, agglomeration).

The object of the present invention consists in proposing a coating composition for automobiles which enables the achievement of optical special effects, in particular strong gloss and glitter effects with a depth action, without complex three-coat finishing of the vehicle parts being necessary.

The object of the present invention furthermore consists in providing a simple process for the coating of automobiles or automobile parts.

An additional object of the invention consists in indicating the use of the said coating composition.

In addition, the object of the present invention consists in providing an automobile paint which meets the said requirements.

The object according to the invention is achieved by a coating composition for an automobile clear coat which comprises a transparent effect pigment.

The object of the invention is furthermore achieved by a process for the coating of automobiles or automobile parts with a clear coat, where a coating composition which comprises a transparent effect pigment is applied as top coating to a substrate which has been pre-coated in advance with at least one coating comprising a base coat, optionally dried and/or cured, and is dried and cured.

The object of the invention is likewise achieved by the use of a coating composition which comprises a transparent effect pigment for the coating of automobiles or automobile parts with a top coating.

The object according to the invention is furthermore achieved by an automobile clear coat which is in the form of a top coat on an automobile or automobile part and consists of a dried and cured coating composition which comprises a transparent effect pigment.

An automobile clear coat in the sense of the present invention is a clear coat for the first finishing of automobiles, which is generally also referred to as OEM (original equipment manufacturers) clear coat. Such coatings are series coatings for the series finishing of automobiles by the automobile manufacturers and differ from other vehicle coatings, coatings for small runs, coatings for commercial vehicles or refinish coatings in the structure and in the application and the way in which they are applied. OEM coatings must successfully meet the specifications of the automobile manufacturers and are approved by them for certain types of vehicle. Due to the precise specification necessary for the coatings, material deviations are not allowed in practice.

Owing to the different objectives, however, OEM clear coats also differ significantly from OEM base coats, as already described briefly above. Whereas base coats serve principally for colouring the automobile and for this purpose the colour, flow and adhesion properties of these paints are achieved via the corresponding additives, the focus in the case of clear coats is the protective and preservation function with respect to disadvantageous external influences. However, it must of course also be possible for the OEM clear coats to be distributed well on the respective substrate, i.e. they must have good flow properties. In addition, a certain auxiliary function for the parallel alignment of effect pigments in the base coat is also attributed to OEM clear coats. These functions are essentially served by the type and amount of the binders and additives selected.

Effect pigments are generally taken to mean pigments which, besides colour, provide an application medium with additional properties, such as, for example, angle dependence of the colour, gloss or texture. A pigment here is defined as a substance consisting of particles which is virtually insoluble in the application medium and which is used as colorant or owing to its corrosion-inhibiting, magnetic, electrical or electromagnetic properties.

The effect pigments include lustre pigments, metal-effect pigments, pearlescent pigments and interference pigments.

Lustre pigments are effect pigments with a predominantly flake-form shape which can be aligned parallel and then have a characteristic lustre due to light reflection. Lustre pigments comprising metal are known as metal-effect pigments. Pearlescent pigments are taken to mean lustre pigments which consist of transparent flakes of high refractive index. If pearlescent pigments of this type also exhibit interference colours, they are known as interference pigments.

Transparent effect pigments in the sense of the present invention are thus lustre pigments, pearlescent pigments and interference pigments which consist of transparent or essentially transparent layers. For the purposes of the present invention, these are taken to mean a support layer and optionally additional layers which generally surround the support layer, where both the support layer and also the layers located thereon transmit incident light to the extent of at least 60%, preferably to the extent of at least 70% or more, in particular to the extent of at least 90%.

The transparent effect pigments employed in accordance with the invention are in flake form and can have either a single-layered or a multilayered structure. If they have a single-layered structure, they consist of high-refractive-index materials, such as, for example, titanium dioxide, or also of low-refractive-index materials, such as a borosilicate, glass, SiO₂, Al₂O₃, natural or synthetic mica, talc or another phyllosilicate, but in particular glass or borosilicate. Low-refractive-index materials only come into consideration here if the difference in the refractive index of the low-refractive-index material compared with the refractive index of the application medium is at least 0.1, but preferably at least 0.3.

Effect pigments having a multilayered structure have a flake-form support comprising a borosilicate, glass, SiO₂, Al₂O₃, natural or synthetic mica, talc or another phyllosilicate. At least one inorganic coating consisting of TiO₂, ZrO₂, SnO₂, SiO₂, Al₂O₃, Fe₂O₃ or Cr₂O₃, or mixtures or mixed oxides thereof, is arranged on this support. The first inorganic coating located directly on the support is different from the support here. The at least one inorganic coating preferably surrounds the support very substantially or completely.

Of these pigments, the following are particularly preferred:
borosilicate support flake—TiO₂ coating (anatase or rutile)
borosilicate support flake—Fe₂O₃ coating
glass support flake—TiO₂ coating (anatase or rutile)
glass support flake—Fe₂O₃ coating
aluminium oxide support flake—TiO₂ coating (anatase or rutile)
aluminium oxide support flake—Fe₂O₃ coating

Very particular preference is given to
borosilicate support flake—TiO₂ coating (anatase or rutile) and
glass support flake—TiO₂ coating (anatase or rutile).

A plurality of inorganic layers may also be arranged one above the other on the support. In this case, it is advantageous for high- and low-refractive-index layers to alternate in the coating. The above-mentioned materials are high-refractive-index materials in the case of TiO₂, ZrO₂, Fe₂O₃ and Cr₂O₃, while SnO₂, SiO₂, Al₂O₃ count amongst the low-refractive-index materials.

In the case of pigments having a multiple coating, the following are preferred:
borosilicate support flake—TiO₂—SiO₂—TiO₂ coating (TiO₂ in each case anatase or rutile);
glass support flake—TiO₂—SiO₂—TiO₂ coating (TiO₂ in each case anatase or rutile);
aluminium oxide support flake—TiO₂—SiO₂—TiO₂ coating (TiO₂ in each case anatase or rutile);
   but of these in particular that based on a borosilicate or glass support flake.

The length and width dimensions for the transparent effect pigments employed in accordance with the invention are between 2 and 500 μm, preferably between 10 and 200 μm, 10 and 125 μm, and 10 and 100 μm. These dimensions are usually also known as the particle size of the pigments. Although in principle all particle sizes in the above-mentioned range can be employed, relatively coarse pigment fractions are preferred for achieving particularly striking gloss and glitter effects, i.e. those which have a high proportion of pigments having a particle size of 100 μm or larger.

The thickness of the transparent effect pigments is usually between 0.05 and 5 μm, preferably 0.1 to 4.5 μm and particularly preferably 0.2 to 1 μm.

The transparent effect pigments have an aspect ratio (ratio of length to thickness) of at least 2, preferably of at least 10 and particularly preferably of at least 50, but this may also be up to 2000.

In addition to the coatings already described above, the transparent effect pigments employed in accordance with the invention may also have a conventional inorganic and/or organic post-coating. Such coatings are usually applied in order to improve the matching of effect pigments to the respective application medium and to ensure better dispersion, reduction of the settling tendency, improvement of the light fastness, better ability of the pigments to be stirred up again, etc., in the application medium. Examples of coatings of this type are given, inter alia, in EP 0 632 109, U.S. Pat. No. 5,759,255, DE 43 17 019, DE 39 29 423, DE 32 35 017, EP 0 492 223, EP 0 342 533, EP 0 268 918, EP 0 141 174, EP 0 764 191, WO 98/13426 or EP 0 465 805.

The transparent effect pigments employed in accordance with the invention preferably have at least one organic post-coating or at least one inorganic post-coating, but advantageously at least one inorganic post-coating and one organic post-coating.

The transparent effect pigments employed in accordance with the invention are commercially available from various manufacturers under various trade names. Particular preference is given to the use of transparent effect pigments which are offered by Merck KGaA, Darmstadt, Federal Republic of Germany, under the trade names Iriodin® Flash***, Iriodin® Shimmer***, Iriodin® Glitter***, Miraval® Scenic*** and Miraval® Magic***, in each case in various colours. These are pigments based on mica and borosilicate flakes whose particle sizes are in the range from 10 to 200 μm and which have a relatively high proportion of coarse pigments. In the clear coat according to the invention, these pigments exhibit particularly strong gloss and strong point glitter at the same time as a neutral or, if desired, also a clearly visible colour. Owing to the particularly strong glitter effects, the pigments of the Miraval® series are very particularly preferred.

The transparent effect pigments are present in the coating composition according to the invention in an amount of 0.01 to 1% by weight, based on the weight of the coating composition. A proportion of the transparent effect pigments of at most 0.5% by weight, in particular at most 0.3% by weight and very particularly preferably 0.01 to 0.15% by weight, in each case based on the weight of the coating composition, is preferred.

Surprisingly, it has been found that such a small amount of transparent effect pigments does not have a disadvantageous effect on the properties with respect to chemical, mechanical and light stability that a clear coat usually employed for the first finish of vehicles must have. This is not the case even if the transparent effect pigments are provided with one or more coatings comprising titanium dioxide, which is known for its photoactive action and usually causes yellowing of paint coats. Results which substantially correspond to those of clear coats without added pigment can also be achieved in relation to the adhesion properties and the distinctness of image (DOI) of the clear coat. At the same time, however, the small added amounts of transparent effect pigments cause strikingly strong coloured gloss and in particular glitter effects, which cannot be achieved in the case of a conventional two-coat finish even if substantially larger amounts of transparent effect pigments are employed in the base coat.

Besides the transparent effect pigments, the coating composition according to the invention for an automobile clear coat comprises at least one binder which is customary for automobile clear coats and optionally at least one solvent.

The conventional OEM clear-coat compositions, as employed as standard in the industry, can be used here as clear-coat vehicle. Depending on the coating method used and other claims, SBCC1 (1-component solvent borne clear coat), SBCC2 (2-component solvent borne clear coat), WBCC (1-component water borne clear coat) and PCC (powder clear coat) systems are suitable here.

The two first-mentioned systems still have the greatest economic importance worldwide, while WBCC and PCC systems are increasing in importance for environmental reasons owing to their solvent-free composition.

Depending on the coating system selected, various binder systems and crosslinking agents are employed as standard. SBCC1 systems are accordingly frequently built up on the basis of acrylate/melamine or also on the basis of acrylate/melamine/silane, but in some cases also on the basis of carbamate/melamine.

Epoxy resins and polyurethanes are employed both for solvent-borne 1-component systems and for 2-component systems.

Water-borne systems are generally based on polyester acrylates which have been crosslinked with blocked isocyanate and melamine resins. Acrylates, in particular glycidyl methacrylates, also represent the commonest binder/crosslinking agent systems for powder clear coats.

The solids content of the various solvent- and water-borne coating systems is between 40 and about 65% in the case of solvent-borne systems and approximately between 35 and 45% in the case of water-borne systems. In the case of powder coatings, the solids content is 100%.

Whereas the solvent- or water-borne systems are generally applied in dry-layer thicknesses of about 35 to about 50 μm (solvent-borne) and about 35 to about 45 μm (water-borne), layer thicknesses of about 55 to about 65 μm or thicker, preferably 80 to 85 μm, are necessary in the case of powder clear coats in order to achieve an optimum finish result.

Since very good gloss and glitter effects which have a high depth action and in some cases even the optical effect of moved, strongly glittering surfaces can be achieved with the coating compositions according to the invention at dry-layer thicknesses of only about 10 to 20 μm, water- and solvent-borne binder systems are preferred as the basis for the coating compositions according to the invention. The narrow layer-thickness specifications, which give rise to expectations of optimum results with respect to all requisite coating properties in the interplay of base coat and clear coat, can thus best be complied with. This is because excessively thin or also excessively thick (overall) coating layers have disadvantageous effects on the appearance of the automotive finish as a whole, either in an optical respect or also in relation to its chemical and/or mechanical stability.

The coating compositions according to the invention may of course also comprise the conventional assistants and additives which are usually present in clear-coat systems for the series first finishing of automobiles. Besides the requisite crosslinking agents, these are, for example, UV absorbers, HALS (hindered amine light stabiliser) components and additives for degassing, improving the flow behaviour, improving the scratch resistance, improving the adhesion capacity and the like.

Additives for improving the UV stability and increasingly also additives for improving the scratch resistance are of particular importance here. The coating composition according to the invention therefore preferably comprises at least one additive for improving the UV stability and/or for improving the scratch resistance.

The latter can, as increasingly usual recently, also be employed in the form of nanoparticles, preferably in the form of SiO₂ nanoparticles having primary particle sizes of about 5 to about 50 nm. These SiO₂ nanoparticles generally have a surface modification which simplifies incorporation thereof into the various coating systems. However, they are preferably core/shell particles which have a polymer shell, which preferably carries reactive groups, on a nanoscale core in the size order indicated above. SiO₂ nanoparticles having a polyacrylate shell which contains functional OH groups or also other functional groups are particularly suitable for use as scratch-resistant additives in clear coats. The use of the latter in 2-component polyurethane coatings in amounts of 1-5% by weight of solids, based on the non-volatile fraction of the coating, is particularly advantageous.

The invention also relates to a process for the coating of automobiles or automobile parts with a clear coat, where a coating composition described above is applied as top coating to a substrate which has been pre-coated in advance with at least one coating comprising a base coat, optionally dried and/or cured, and is dried and cured.

The coating comprising a base coat here can be a single-layered or a two-layered base coating. Preference is given to a single-layered base coating. The base coating comprises all main substances and assistants usually employed for this purpose, in particular absorption pigments for an opaque coating beneath the clear coat. The base coating may likewise comprise effect pigments. These can be opaque (metal-effect pigments) or transparent and have the same colour and size as the transparent effect pigments employed in the clear coat, but may also be different from the latter and cause optical effects which differ significantly from the optical effects of the transparent effect pigments in the clear coat. In particular, they may contribute to angle-dependent colour changes or a metallic overall picture of the finish as a whole, on which the special effects caused by the transparent effect pigments in the clear coat are partially superimposed, which results in “gloss or glitter spots” on the surface of the automobiles or automobile parts.

The substrates employed for the coating with a base coat are bodies or body parts of automobiles which have been pre-treated in the usual manner (for example e-coat, filler), which usually consist of metals, plastics or composite materials. These are provided with a base coat in a known manner by means of the conventional means and plants.

The further coating with a coating composition in accordance with the present invention for the production of a clear coat as outermost, final coat can be carried out with or without interim drying or interim curing and likewise in the conventional plants. Brief interim drying lasting a few minutes, but no interim curing is usually carried out.

The coating composition according to the invention is applied to the substrate which has been pre-treated and coated with at least one coating comprising a base coat, and dried. The layer thickness of the coating here is preferably about 35 to about 50 μm. The entire coating system is subsequently cured. This is usually carried out for a period of 10 to 30 minutes at temperatures of about 150° C. However, if the corresponding components have been incorporated into the coating layers, UV curing is also possible.

The present invention also relates to the use of the coating composition according to the invention for the coating of automobiles or automobile parts with a top coat. This top coat is a clear coat which, besides the transparent effect pigments present in accordance with the invention, comprises no further colouring pigments. Apart from any nanoparticles added for improving the scratch resistance, it is preferred for no further particulate materials to be present in this clear coat.

The present invention likewise relates to an automobile clear coat which is present as top coat on an automobile or automobile part and consists of a dried and cured coating composition, as described above.

The automobile clear coat according to the invention is essentially transparent to the colours and other optical effects generated by the underlying base coat. However, the transparent effect pigments present therein generate additional coloured or colourless gloss or glitter effects, which are superimposed pointwise on the optical appearance achieved by the base coat and thus generate a vivid sparkle, depending on the relative movement of the observer to the coating surface. These optically very attractive effects can be obtained with minimal use of effect pigments in the clear coat. At the same time, the particular requirements generally made of the mechanical, chemical and light stability of the clear coat continue to be complied with.

The coating composition according to the invention, a clear coat obtained therefrom, and the coating process according to the invention have enabled the development of a coating system, preferably a two-step coating system, for the finishing of automobiles and automobile parts for series manufacturers which can be integrated without problems into the automobile painting systems present worldwide, with use of small amounts of materials in the form of effect pigments, a simple coating process and by means of conventional paint constituents and coating equipment. Automobile paints are obtained which combine the optical properties generated by the base coat with optical special effects caused by the clear coats produced in accordance with the invention. The transparent effect pigments used for this purpose are available on the market. The finishing as a whole is carried out in an economical manner, since a two-coat finish is sufficient. Reductions in the chemical, mechanical or light stability of the finish as a whole do not have to be accepted, even if use is made of commercially available effect pigments, which are generally regarded as photoactive.

The optical effects obtained are extremely attractive and attention-generating. They provide high-value automobiles with a visually attractive appearance, which also meets high requirements. Accordingly, they are a valuable addition to optical special effects which are already customary on automobile paints, such as angle-dependent colour impressions or metallic finishes.

The present invention will be explained below with reference to examples according to the invention, but is not restricted thereto. All percentage data, unless indicated otherwise, are in per cent by weight, based on the respective coating composition.

### EXAMPLE 1

A coating composition comprising a commercially available water-borne OEM base-coat system, obtainable, for example, from BASF Coatings AG, Germany, which has been tinted blue-black with conventional absorption pigments is applied to 6 bonder sheets (100×200 mm, filled white) by means of a Lab-Painter automatic coating machine. The coating is carried out in 2 spray operations by means of a 1.4 mm nozzle, at a spray pressure of 4000 mbar and a speed of 500 mm/s, and at a spray separation of 27 cm. A dry-layer thickness of 13-15 μm is achieved. The coated metal sheets are dried at room temperature for 10 minutes and subsequently at 80° C. for 10 minutes.

6 different clear-coat coating compositions are prepared, each comprising as basis a commercially available 1-component solvent-borne clear coat (obtainable, for example, from BASF Coatings AG) and in each case different concentrations of 0/0.1%/0.3%/0.5%/1% or 2% of an effect pigment based on borosilicate flakes (Miraval® Scenic White WR, particle size 10-100 μm, Merck KGaA, Germany). The viscosity of the base clear coat here is not changed by the small amount of added effect pigment.

The metal sheets pre-coated with a blue-black base coat in the first step are likewise coated by means of a Lab-Painter automatic coating machine with in each case one of the resultant clear-coat coating compositions. The finishing is carried out in 2 spray operations by means of a 1.4 mm nozzle, at a spray pressure of 4500 mbar and a speed of 850 mm/s, and at a spray separation of 27 cm. A dry-layer thickness of 40-45 μm is achieved. The variously coated metal sheets are dried at room temperature for 10 minutes and subsequently dried and cured at 125° C. for 25 minutes. They are then allowed to cool to ambient temperature.

The coated metal sheets whose clear coat comprises the effect pigment exhibit a vivid, bright to in places coloured glitter and sparkle on a blue-black background when observed under a daylight source at a steep viewing angle, giving the impression of glittering dots. If the location of the light source or viewer is changed relative to the coated metal sheet, an apparent “movement” of the glitter particles on the blue-black background is evident. Even at the lowest concentration of the effect pigment of 0.1%, a clear optical effect is perceptible, becoming more enhanced with increasing proportion of effect pigment. At an effect-pigment proportion of 1%, large relative parts of the surface of the metal sheet are already apparently covered with glitter particles, whereas at a proportion of 2%, the individual-particle impression has already virtually disappeared completely and an apparently entirely glittering surface is present.

The comparative sample comprising 0% of effect pigment in the clear coat exhibits, as expected, only the blue-black coloration of the base coat and the usual uniform coating gloss reinforced by the clear coat.

For the determination of the optical and mechanical properties of the coated test sheets, gloss (in accordance with DIN 67 530), distinctness of image (DOI) in accordance with ASTM E 430-91 and dullness (Byk Wavescan) are measured as optical parameters, and, for assessment of the mechanical parameters, an adhesion test is carried out in accordance with EN ISO 2409 (cross-hatch), in each case before and after a condensation test (DIN 50017, condensation test climates, 240 hours, 40° C., water-saturated atmosphere) with sampling before exposure (A), immediately after completion of the exposure (0) and 1, 4 and 24 hours after completion of the exposure. The results are shown in Table 1 below.

TABLE 1

| Effect | | | | | | | | | | |
|---|---|---|---|---|---|---|---|---|---|---|
| pigment | Crosshatch | | | | | DOI (Dorigon) | | | | |
| in the | (adhesion) | | Gloss | | | Dullness | | | | |
| clear coat | A | 0 | A | 1 | 24 | A | 0 | 1 | 4 | 24 |
| None | 0 | 0 | 89 | 89 | 89 | 95 | 96 | 96 | 96 | 96 |
| | | | | | | 1 | 1 | 1 | 1 | 1 |
| 0.1% | 0 | 0 | 89 | 78 | 80 | 91 | 82 | 85 | 84 | 85 |
| | | | | | | 9 | 25 | 21 | 23 | 22 |
| 0.3% | 0 | 0 | 86 | 58 | 64 | 85 | 71 | 74 | 74 | 75 |
| | | | | | | 21 | 46 | 41 | 42 | 41 |
| 0.5% | 0 | 0 | 81 | 42 | 49 | 81 | 67 | 68 | 69 | 69 |
| | | | | | | 28 | 53 | 51 | 51 | 50 |
| 1% | 0 | 0 | 77 | 20 | 33 | 75 | * | 64 | 65 | 66 |
| | | | | | | 40 | | 59 | 57 | 57 |
| 2% | 0 | 0 | 65 | 8 | 18 | 69 | * | * | * | 64 |
| | | | | | | 50 | | | | 50 |

* outside the measurement range

The values shown in Table 1 show that the adhesion of the clear coat pigmented in accordance with the invention to the base coat of the test metal sheets is not impaired even at high effect-pigment concentrations in the clear coat. Although gloss and distinctness of image are reduced on addition of low concentrations of effect pigment to the clear coat, the values recover with increasing time separation from the exposure to condensation, and tolerable results are achieved. The losses in gloss and distinctness of image are in addition virtually imperceptible visually due to the strong glitter effect in the pigmented clear coat. Only from addition of about 0.5% of effect pigment to the clear coat do gloss, distinctness of image and haze (dullness) reach values which can no longer fully compensate for the optical impairment in the quality of the clear coat and also can no longer be balanced by the strong glitter effect achieved. Whether the results achieved therewith are still tolerable then depends on the focus of the particular user. However, if the addition of effect pigment exceeds 1% by weight in the coating composition, the clear coats are no longer so highly suitable for practical use, in particular owing to the values for distinctness of image and haze.

### EXAMPLE 2

In order to investigate the mechanical robustness of clear coats pigmented in accordance with the invention, they are mixed with various amounts of effect pigment and with various amounts of scratch-resistant additives and tested for their scratch resistance.

The checking of the scratch resistance is carried out, for example, by means of a motor-driven Atlas CM-5 AATCC crockmeter using 281Q WETORDRY™ abrasive paper (3M) with a grain size of 9 μm. During the test, the rubbing finger of the crockmeter covered with the abrasive paper presses onto the coated sample surface with a weight of 9 newtons. The abrasive paper measuring 5×5 cm is replaced after each scratch mark. 10 double strokes, each with a length of 100 mm, are carried out (see also Daimler standard PBODC 390).

The sample metal sheets measuring 200×100 mm in accordance with Example 1 are firstly coated with the base coat described in Example 1 and subsequently, likewise analogously to Example 1, with various pigmented and unpigmented clear coats in the compositions indicated below. The test is carried out at the earliest 72 hours after drying of the clear coat.

The gloss (viewing angle 20°) of the test sheets is measured transversely to the scratch direction, for example using a “Micro-haze plus”, “Mikro-TRI-Gloss” or “Micro-Gloss 20°” (all Byk-Gardner) or equivalent instruments.

6 different effect pigments (based on borosilicate flakes or Al₂O₃ flakes) are introduced into the clear coat in a concentration of in each case 0.3 or 1% by vol., based on the clear coat. In addition, in each case 0 or 5% by vol. of a scratch-resistant additive (Tivida™ AS 1010, core/shell particles comprising nanoscale SiO₂, primary particle size 9 nm, with polyacrylate shell, 50% by weight dispersion in butyl acetate, product from Merck KGaA, Germany) are introduced into the clear coat. The gloss values obtained for the test sheets are shown in Table 2.

TABLE 2

| | | Proportion of | | |
|---|---|---|---|---|
| | Proportion | scratch-resistant additive | Gloss 1 | Gloss 2 |
| Effect pigment | % by vol. | % by vol. | (20°) | (20°) |
| None | — | 0 | 88.5 | 27.7 |
| None | — | 5 | 88.0 | 70.2 |
| Borosilicate | 0.3 | 0 | 87.2 | 34.8 |
| base A | | | | |
| Borosilicate | 0.3 | 5 | 88.3 | 67.0 |
| base A | | | | |
| Borosilicate | 0.3 | 0 | 90.7 | 34.8 |
| base B | | | | |
| Borosilicate | 0.3 | 5 | 88.5 | 68.0 |
| base B | | | | |
| Al₂O₃ base A | 0.3 | 0 | 90.8 | 32.3 |
| Al₂O₃ base A | 0.3 | 5 | 88.6 | 69.2 |
| Al₂O₃ base B | 0.3 | 0 | 90.1 | 33.8 |
| Al₂O₃ base B | 0.3 | 5 | 87.9 | 71.3 |
| Al₂O₃ base C | 0.3 | 0 | 89.1 | 29.4 |
| Al₂O₃ base C | 0.3 | 5 | 88.8 | 71.2 |
| Al₂O₃ base D | 0.3 | 0 | 90.0 | 30.0 |
| Al₂O₃ base D | 0.3 | 5 | 88.0 | 70.1 |
| Borosilicate | 1 | 0 | 87.1 | 53.1 |
| base A | | | | |
| Borosilicate | 1 | 5 | 85.9 | 71.7 |
| base A | | | | |
| Borosilicate | 1 | 0 | 88.4 | 24.4 |
| base B | | | | |
| Borosilicate | 1 | 5 | 87.0 | 67.1 |
| base B | | | | |
| Al₂O₃ base A | 1 | 0 | 89.4 | 28.7 |
| Al₂O₃ base A | 1 | 5 | 86.9 | 69.7 |
| Al₂O₃ base B | 1 | 0 | 84.3 | 21.3 |
| Al₂O₃ base B | 1 | 5 | 87.1 | 73.0 |
| Al₂O₃ base C | 1 | 0 | 89.3 | 29.3 |
| Al₂O₃ base C | 1 | 5 | 88.4 | 36.4 |
| Al₂O₃ base D | 1 | 0 | 86.4 | 68.8 |
| Al₂O₃ base D | 1 | 5 | 88.0 | 70.1 |

Gloss 1: Gloss value before mechanical loading (20°)
Gloss 2: Gloss value after mechanical loading (20°)
Pigments A and B based on borosilicate with one or more metal-oxide layers are pigments from Merck KGaA, which are marketed under the trade name Miraval ®, which are different in colour and/or particle-size fraction and/or surface post-coating.
Pigments A to D based on Al₂O₃ flakes with one or more metal-oxide layers are pigments from Merck KGaA, which are marketed under the trade name Xirallic ®, which are different in colour and/or particle-size fraction and/or surface post-coating.

It can clearly be seen from the results in Table 2 that the addition of scratch-resistance improvers results in a significant improvement in the residual gloss values after mechanical scratching both in the case of pigmented and in the case of unpigmented clear coats. The presence of an effect pigment, irrespective of the amount added, in no way disadvantageously impairs the action of the scratch-resistant additive, but instead even augments it in some cases.

1. Coating composition for an automobile clear coat, comprising a transparent effect pigment.

2. Coating composition according to claim 1, characterised in that the transparent effect pigment is a pigment which has a flake-form support comprising a borosilicate, glass, SiO₂, Al₂O₃, natural or synthetic mica, talc or another phyllosilicate.

3. Coating composition according to claim 1, characterised in that the transparent effect pigment on the support has at least one inorganic coating consisting of TiO₂, ZrO₂, SnO₂, SiO₂, Al₂O₃, Fe₂O₃ or Cr₂O₃, or mixtures or mixed oxides thereof, where the first inorganic coating located directly on the support is different from the support.

4. Coating composition according to claim 1, characterised in that the transparent effect pigment is present in the coating composition in an amount of 0.01 to 1% by weight, based on the weight of the coating composition.

5. Coating composition according to claim 4, characterised in that the transparent effect pigment is present in the coating composition in an amount of at most 0.5% by weight.

6. Coating composition according to claim 1, additionally comprising at least one solvent.

7. Coating composition according to claim 1, additionally comprising at least one additive for improving the UV stability and/or for improving the scratch resistance.

8. Coating composition according to claim 7, characterised in that the additive for improving the scratch resistance comprises core/shell particles comprising a core of SiO₂, where the core has a size of 5 to 50 nm, and a polymer shell.

9. A process for the coating of automobiles or automobile parts with a clear coat, comprising applying a coating composition according to claim 1 as a top coating to a substrate which has been pre-coated in advance with at least one coating comprising a base coat, and drying and curing said coating composition.

10. A method of using a coating composition according to claim 1 comprising coating of automobiles or automobile parts with said coating composition according to claim 1 to form a top coat.

11. Automobile clear coat which is in the form of a top coat on an automobile or automobile part and consists of a dried and cured coating composition according to claim 1.
